(19) United States
(12) Patent Application Publication
(10) Pub. No.: US 2023/0397129 A1
(43) Pub. Date: Dec. 7, 2023

(54) WIRELESS COMMUNICATION REFERENCE SIGNAL SELECTION BASED ON EXPOSURE LIMITATIONS

(71) Applicant: Telefonaktiebolaget LM Ericsson (publ), Stockholm (SE)

(72) Inventors: Claes TIDESTAV, Bålsta (SE); Andreas NILSSON, Göteborg (SE); Eleftherios KARIPIDIS, Stockholm (SE); Daniele DAVOLI, Stockholm (SE)

(21) Appl. No.: 18/250,036

(22) PCT Filed: Oct. 22, 2021
(86) PCT No.: PCT/SE2021/051071

§ 371 Date: Apr. 21, 2023

Related U.S. Application Data
(60) Provisional application No. 63/104,381, filed on Oct. 22, 2020.

(51) Int. Cl. H04W 52/36; H04W 52/42; H04W 52/32

(52) U.S. Cl. CPC H04W 52/367; H04W 52/42; H04W 52/325

(57) ABSTRACT

A method, network node and wireless device (WD) for reference signal selection and use at power limitation are disclosed. According to one aspect, a method in a wireless device, WD, configured to communicate with a network node is provided. The method includes determining that a maximum permissible emission event has occurred for a current spatial domain transmission filter of the WD, selecting at least one candidate downlink reference signal and reporting the selected candidate downlink reference signal to the network node.

### TECHNICAL FIELD

The present disclosure relates to wireless communications, and in particular, to candidate reference signal selection and use based on exposure limitations for the reference signal.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

Wireless communication systems according to the 3GPP may include one or more of the following channels:
A physical downlink control channel, PDCCH;
A physical uplink control channel, PUCCH;
A physical downlink shared channel, PDSCH;
A physical uplink shared channel, PUSCH;
A physical broadcast channel, PBCH; and
A physical random access channel, PRACH.

Setting output power levels of transmitters of radio base stations for downlink transmissions to a WD and setting output power levels of transmitters of a WD for uplink transmissions in wireless communication systems is commonly referred to as power control (PC).

In LTE, PC mechanisms can be categorized into the groups (i) open-loop, (ii) closed-loop, and (iii) combined open- and closed-loop. These differ in what input is used to determine the transmit power. In the open-loop case, the transmitter measures some signal sent from the receiver, and the transmitter sets its output power based on this. In the closed-loop case, the receiver measures the signal from the transmitter, and based on this sends a Transmit Power Control (TPC) command to the transmitter, which then sets its transmit power accordingly. In a combined open- and closed-loop scheme, both inputs are used to set the transmit power.

In NR, the WD determines the transmit power of the physical uplink shared channel (PUSCH) as:

P_{PUSCH}=min(P_{CMAX}, P₀(j)+α(j)·PL(q)+10log₁₀(2^{μ}·M_{RB})+Δ_{TF}+δ(l)) (1)

where,
P_{CMAX} is the configured WD transmit power;
P₀(j) is a network-configurable parameter, which can be interpreted as a target received power;
α(j) is a network-configurable parameter, which describes to what extent the power control compensates for the pathloss;
PL(q) is an estimate of the uplink pathloss;
μ is related to the subcarrier spacing Δf used for the PUSCH transmission: Δf=15 kHz·2^{μ};
M_{RB} is the number of resource blocks assigned for the PUSCH transmission;
Δ_{TF} is an adjustment related to the utilized modulation and coding used for the PUSCH transmission; and
δ(l) is the closed-loop adjustment.

In NR, beam-based power control has also been introduced to take beam forming into account during power control. This provides a generalization to the basic power control procedure in three ways:
1. The WD may perform several pathloss estimation processes;
2. The WD may be configured with several sets of open-loop power control parameter sets; and
3. The WD may be configured with two closed-loop power control loops.

For every scheduling assignment, the network (NW) via a network node may provide an indication for each of the above three items to steer the uplink (UL) power control.

At high frequencies, it is likely that the WDs will be equipped with several antenna panels. From each such antenna panel, the WD may form a number of beams.

It is unlikely that the transmit power may be shared between panels: each antenna panel may have its own power amplifier, potentially with different maximum output power.

In NR 3GPP Release 15 (3GPP Rel-15), the network node may schedule transmission over any of the antenna panels with which the WD is equipped. The network node may base its scheduling decision on previously received sounding reference signals (SRS), where different SRS resources may have been transmitted from different panels. By measuring the received power for each of these SRS resources, the network node can determine which SRS was transmitted over the most favorable channel conditions. In subsequent scheduling assignments, the network node may instruct the WD to transmit the physical uplink shared channel (PUSCH) using the same beam/precoder as was used to transmit the indicated SRS.

The WD may also apply different maximum power reductions for the different panels. To ensure compliance with applicable electromagnetic energy absorption requirements, proximity detection is used to address such requirements that require a lower maximum output power. Such regulations are known as maximum permissible emissions (MPE) and may also be understood to mean maximum permissible exposure.

3GPP Technical Specification (TS) 38.101-2 v16.5.0, section 6.2.4, specifies that the WD shall be able to report that it is reducing its transmit power due to MPE. What else to include in the report has not been specified by the 3GPP.

At high frequencies, the WD may use different transmission beams in the uplink (UL). Also, the base station (gNB, hereinafter referred to as a network node) may instruct the WD which beam to use. These instructions are conveyed using so-called spatial relations. A spatial relation is used in NR to refer to a spatial relationship between an UL channel or signal such as PUCCH, a PUSCH and a SRS, and a downlink (DL) (or UL) reference signal (RS), such as channel state information reference signal (CSI-RS), synchronization signal block (SSB), or SRS. If an UL channel or signal is spatially related to a DL RS, the WD may use the DL RS to determine in which beam to transmit the UL channel. More precisely, the WD should transmit the UL channel or signal with the same spatial domain transmission filter used for the reception of the DL RS.

If an UL channel or signal is spatially related to a UL SRS, then the WD should apply the same spatial domain transmission filter for the transmission for the UL channel or signal as the one used to transmit the SRS.

Using DL RSs as the source RS in a spatial relation is very effective when the WD can transmit the UL signal in the opposite direction from which it previously received the DL RS, or in other words, if the WD can achieve the same transmit (Tx) antenna gain during transmission as the antenna gain it achieved during reception. This capability (known as beam correspondence) will not always be perfect: due to, e.g., imperfect calibration, and the UL Tx beam may point in another direction, resulting in a loss in UL coverage. To improve the performance in this situation, UL beam management based on SRS sweeping can be used, as outlined in FIG. 1. To achieve optimum performance, the procedure depicted in FIG. 1 should be repeated as soon as the WDs Tx beam changes.

UL beam management using an SRS sweep is shown in the example of FIG. 1. In a first step (Step 1), the WD transmits a series of UL signals (SRS resources), using different Tx beams. The network node, e.g., gNB, then performs measurements for each of the SRS transmissions, and determines which SRS transmission was received with the best quality, or highest signal quality. The network node, e.g., gNB, then signals the preferred SRS resource to the WD (Step 2). The WD subsequently transmits the PUSCH in the same beam used to transmit the preferred SRS resource (Step 3).

If the WD only reports that it is reducing its transmit power due to regulatory requirements, the network node cannot directly act on that information. The network node, e.g., gNB, does not know whether it can instruct the WD to use another panel for UL transmission.

### SUMMARY

Some embodiments advantageously provide methods, network nodes and WDs for beam reporting at power limitation.

Some embodiments include more information in the power management maximum power reduction (P-MPR) report to make it possible for the network node to continue the communication. This may speed up beam selection in case of an MPE event.

According to one aspect of the present disclosure, a method in a wireless device, WD, that is configured to communicate with a network node is provided. The method includes determining that a maximum permissible emission event has occurred for a current spatial domain transmission filter of the WD, selecting at least one candidate downlink reference signal, and reporting the selected candidate downlink reference signal to the network node.

According to one or more embodiments of this aspect, the candidate downlink reference signal corresponds to a candidate spatial domain transmission filter of the WD. According to further embodiments, the WD may receive from the network node an indication of a spatial domain transmission filter to be used by the WD for uplink transmissions. According to one or more embodiments of this aspect, the reporting further includes reporting quality information of the candidate downlink reference signal to the network node. According to one or more embodiments of this aspect, the quality information includes a difference in quality between using the current spatial domain transmission filter and using a spatial domain transmission filter corresponding to the selected candidate downlink reference signal for an uplink, UL, transmission, taking a reduction of transmit power for the current spatial domain transmission filter into account.

According to one or more embodiments of this aspect, the candidate downlink reference signal is a synchronization signal block, SSB, signal or a channel state information reference signal, CSI-RS. According to one or more embodiments of this aspect, the candidate downlink reference signal includes a plurality of candidate downlink reference signals where the reporting includes reporting quality information of a first candidate downlink reference signal of the plurality of candidate downlink reference signals and reporting a difference between the quality information of the first candidate downlink reference signal and corresponding quality information of at least one of the remaining candidate downlink reference signals of the plurality of candidate downlink reference signals. According to one or more embodiments of this aspect, the reporting further includes reporting a power management maximum power reduction, P-MPR, value for a spatial domain transmission filter corresponding to the selected candidate downlink reference signal.

According to another aspect of the present disclosure, a wireless device, WD, configured to communicate with a network node is provided. The WD includes processing circuitry configured to: determine that a maximum permissible emission event has occurred for a current spatial domain transmission filter of the WD, and select at least one candidate downlink reference signal. The WD includes a radio interface in communication with the processing circuitry and configured to: report the selected candidate downlink reference signal to the network node.

According to one or more embodiments of this aspect, the candidate downlink reference signal corresponds to a candidate spatial domain transmission filter of the WD. According to one or more embodiments of this aspect, the radio interface is further configured to receive from the network node an indication of a spatial domain transmission filter to be used by the WD for uplink transmissions. According to one or more embodiments of this aspect, the radio interface being configured to report further comprises the radio interface being configured to report quality information of the candidate downlink reference signal to the network node.

According to one or more embodiments of this aspect, the quality information includes a difference in quality between using the current spatial domain transmission filter and using a spatial domain transmission filter corresponding to the selected candidate downlink reference signal for an uplink, UL, transmission, taking a reduction of transmit power for the current spatial domain transmission filter into account. According to one or more embodiments of this aspect, the candidate downlink reference signal is a synchronization signal block, SSB, signal or a channel state information reference signal, CSI-RS. According to one or more embodiments of this aspect, the candidate downlink reference signal comprises a plurality of candidate downlink reference signals where the reporting includes reporting quality information of a first candidate downlink reference signal of the plurality of candidate downlink reference signals and reporting a difference between the quality information of the first candidate downlink reference signal and corresponding quality information of at least one of the remaining candidate downlink reference signals of the plurality of candidate downlink reference signals. According to one or more embodiments of this aspect, the radio interface being configured to report further comprises the radio interface being configured to report a power management maximum power reduction, P-MPR, value for a spatial domain transmission filter corresponding to the selected candidate downlink reference signal.

According to another aspect of the disclosure, a method in a network node that is configured to communicate with a wireless device, WD, is provided. The method includes receiving from the WD a maximum permissible emission, MPE, report providing a candidate downlink reference signal, and selecting, based on the provided candidate downlink reference signal, a downlink reference signal corresponding to a spatial domain transmission filter to be used by the WD for subsequent uplink transmissions.

According to one or more embodiments of this aspect, the method further includes transmitting to the WD an indication of the spatial domain transmission filter to be used by the WD for uplink transmissions. According to one or more embodiments of this aspect, the receiving further comprises receiving quality information of the candidate downlink reference signal from the WD.

According to one or more embodiments of this aspect, the selected downlink reference signal is one of a current downlink reference signal corresponding to a current spatial domain transmission filter used by the WD for uplink transmissions and the provided candidate downlink reference signal corresponding to a candidate spatial domain transmission filter of the WD for subsequent uplink transmissions. According to one or more embodiments of this aspect, selecting the downlink reference signal corresponding to the spatial domain transmission filter to be used by the WD for subsequent uplink transmissions includes selecting an uplink-downlink beam pair that provides a highest path gain between the network node and the WD.

According to another aspect of the disclosure, a network node configured to communicate with a wireless device, WD is provided. The network node includes a radio interface configured to receive from the WD a maximum permissible emission, MPE, report providing a candidate downlink reference signal. The network node 16 includes processing circuitry in communication with the radio interface and configured to select, based on the provided candidate downlink reference signal, a downlink reference signal corresponding to a spatial domain transmission filter to be used by the WD for subsequent uplink transmissions.

According to one or more embodiments of this aspect, the radio interface is configured to transmit to the WD an indication of the spatial domain transmission filter to be used by the WD for uplink transmissions. According to one or more embodiments of this aspect, the radio interface being configured to receive further includes the radio interface being configured to receive quality information of the candidate downlink reference signal from the WD.

According to one or more embodiments of this aspect, the selected downlink reference signal is one of a current downlink reference signal corresponding to a current spatial domain transmission filter used by the WD for uplink transmissions and the provided candidate downlink reference signal corresponding to a candidate spatial domain transmission filter of the WD for subsequent uplink transmissions.

According to one or more embodiments of this aspect, selecting the downlink reference signal corresponding to the spatial domain transmission filter to be used by the WD for subsequent uplink transmissions includes selecting an uplink-downlink beam pair that provides a highest path gain between the network node and the WD.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates SRS sweeping;

FIG. 2 illustrates MPE reporting;

FIG. 3 is a schematic diagram of an example network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating example methods implemented in a communication system including a host computer, a network node and a wireless device for executing a client application at a wireless device according to some embodiments of the present disclosure;

FIG. 6 is a flowchart illustrating example methods implemented in a communication system including a host computer, a network node and a wireless device for receiving user data at a wireless device according to some embodiments of the present disclosure;

FIG. 7 is a flowchart illustrating example methods implemented in a communication system including a host computer, a network node and a wireless device for receiving user data from the wireless device at a host computer according to some embodiments of the present disclosure;

FIG. 8 is a flowchart illustrating example methods implemented in a communication system including a host computer, a network node and a wireless device for receiving user data at a host computer according to some embodiments of the present disclosure;

FIG. 9 is a flowchart of an example process in a network node for beam reporting at power limitation according to some embodiments of the present disclosure;

FIG. 10 is a flowchart of an example process in a wireless device for beam reporting at power limitation;

FIG. 11 is a flowchart of another example process in a wireless device for beam reporting at power limitation; and

FIG. 12 is a flowchart of another example process in a network node for beam reporting at power limitation according to some embodiments of the present disclosure.

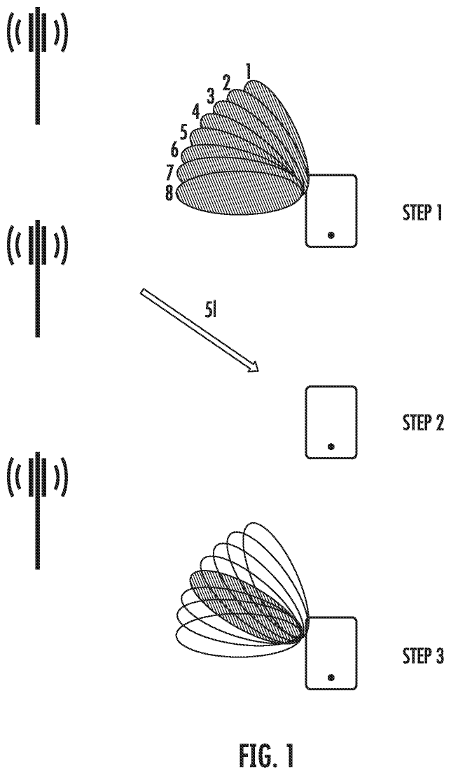

### DETAILED DESCRIPTION

Before describing in detail example embodiments, it is noted that the embodiments reside primarily in combinations of apparatus components and processing steps related to beam reporting at power limitation. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

A method, network node and wireless device (WD) for beam reporting at power limitation are disclosed. According to one aspect, a method in a WD includes transmitting to the network node a candidate downlink reference signal (RS), and receiving from the network node an instruction to use an uplink beam corresponding to the candidate RS in future uplink transmissions.

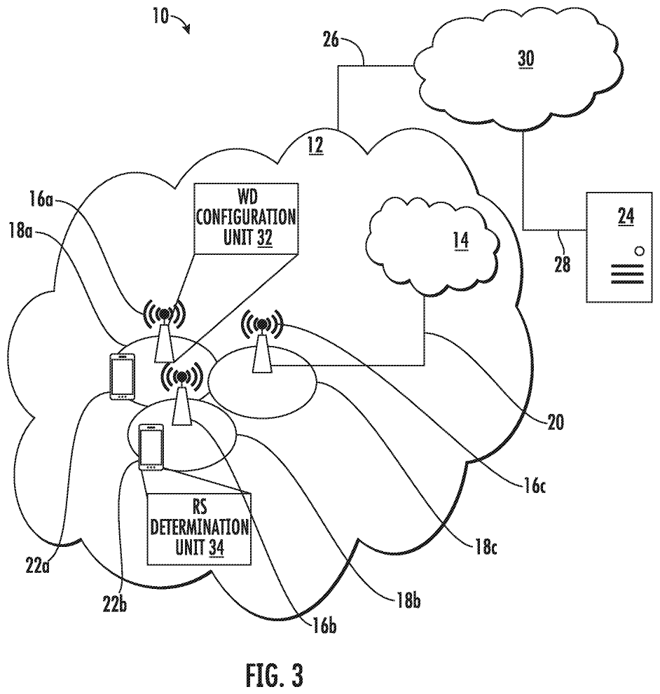

Returning again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a WD configuration unit 32 which is configured to select which uplink beam the WD is to use for future uplink transmissions based at least in part on at least one received signal measurement. The WD configuration unit 32 may further be configured to configure a WD to use a candidate downlink RS for future uplink transmission. The WD configuration unit 32 may also or alternatively be configured to select which uplink beam the WD 22 is to use for future uplink transmissions. A wireless device 22 is configured to include an RS determination unit 34 which is configured to determine whether a maximum permissible exposure limitation event has occurred for an associated reference signal. An uplink beam may correspond to a spatial filter associated with a transmission configuration indicator (TCI) state for uplink transmissions. An uplink beam may also correspond to an antenna panel and be logically identified with the antenna panel.

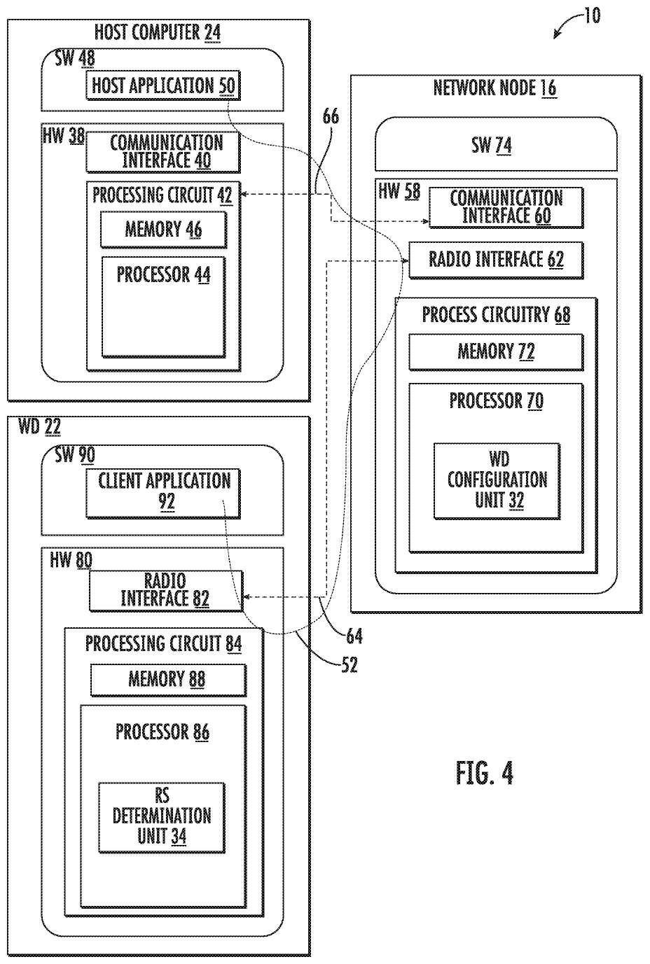

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a WD configuration unit 32 which is configured to select which uplink beam the WD is to use for future uplink transmissions based at least in part on at least one received signal measurement. The WD configuration unit 32 may further be configured to configure a WD to use a candidate downlink RS for future uplink transmission. The WD configuration unit 32 may also or alternatively be configured to select which uplink beam the WD 22 is to use for future uplink transmissions.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an RS determination unit 34 which is configured to select a candidate reference signal for each uplink beam for which transmit power is determined to be reduced. The RS determination unit 34 may be configured to determine a candidate downlink RS. The RS determination unit 34 may be configured to determine whether a maximum permissible exposure limitation event has occurred for an associated reference signal. In some embodiments, the maximum permissible exposure limitation event is deemed to occur when an maximum permissible radiation threshold is exceeded. In some embodiments, the maximum permissible radiation threshold event is deemed to occur when an amount of WD output power reduction exceeds a threshold.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as WD configuration unit 32, and RS determination unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

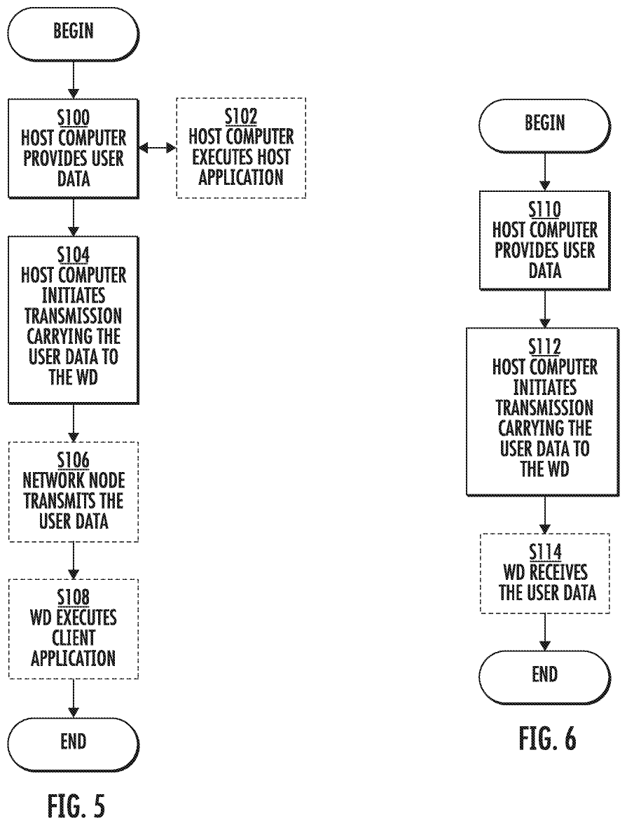

FIG. 5 is a flowchart illustrating an example method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

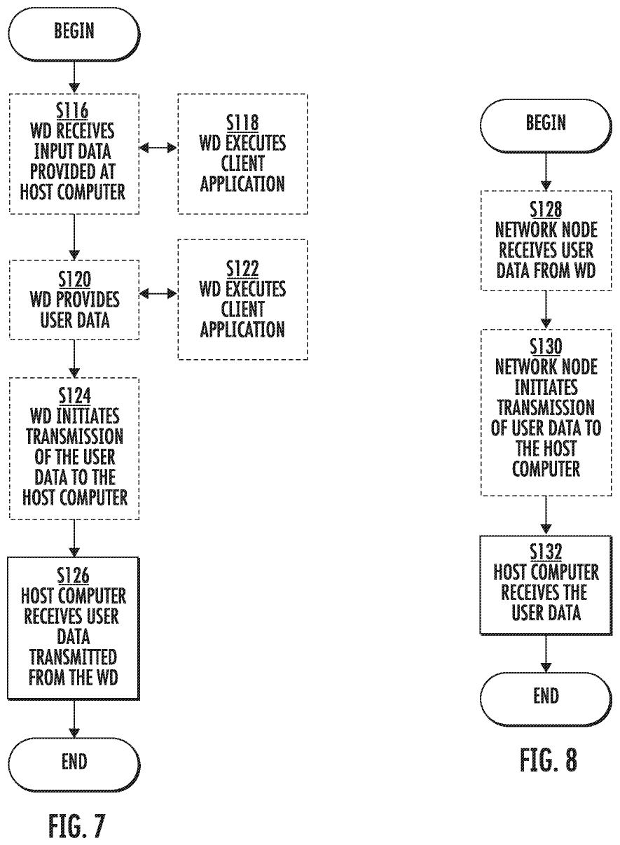

FIG. 7 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

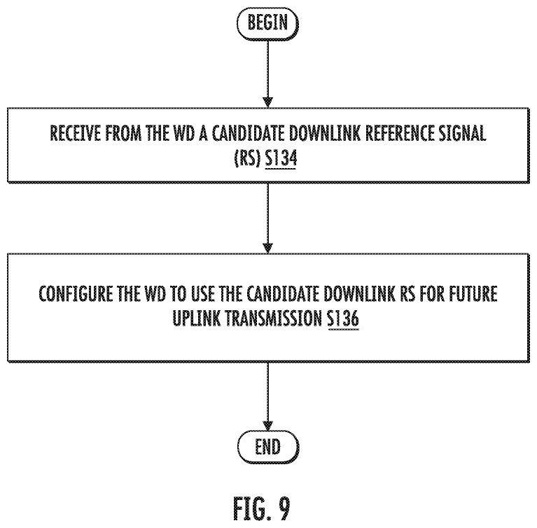

FIG. 9 is a flowchart of an example process in a network node 16 for beam reporting at power limitation. One or more blocks described herein may be performed by one or more elements of network node 16 such as by one or more of processing circuitry 68 (including the WD configuration unit 32), processor 70, radio interface 62 and/or communication interface 60. Network node 16 such as via processing circuitry 68 and/or processor 70 and/or radio interface 62 and/or communication interface 60 is configured to receive from the WD a candidate downlink reference signal (RS) (Block S134). The process also includes configuring the WD to use the candidate downlink RS for future uplink transmission (Block S136).

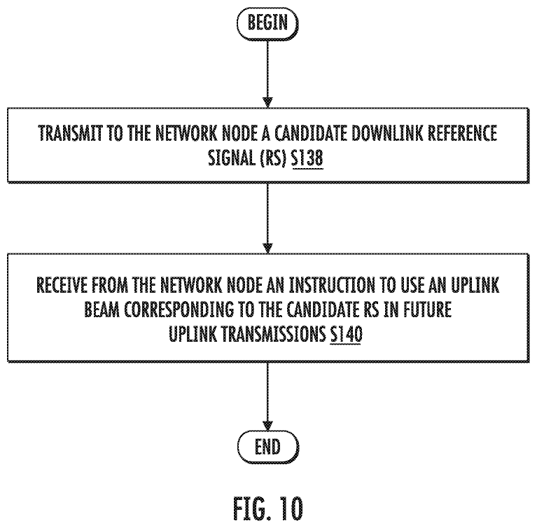

FIG. 10 is a flowchart of an example process in a wireless device 22 according to some embodiments of the present disclosure. One or more blocks described herein may be performed by one or more elements of wireless device 22 such as by one or more of processing circuitry 84 (including the RS determination unit 34), processor 86, radio interface 82 and/or communication interface 60. Wireless device 22 such as via processing circuitry 84 and/or processor 86 and/or radio interface 82 is configured to transmit to the network node a candidate downlink reference signal (RS) (Block S138). The process also includes receiving from the network node an instruction to use an uplink beam corresponding to the candidate RS in future uplink transmissions (Block S140).

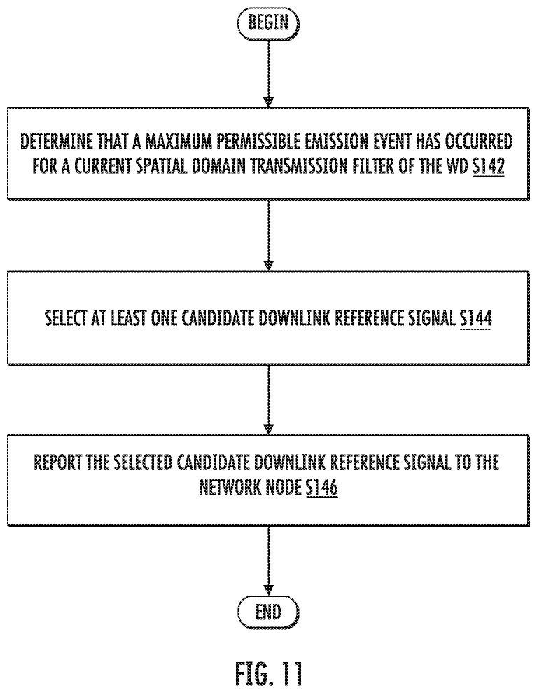

FIG. 11 is a flowchart of another example process in a wireless device 22 according to some embodiments of the present disclosure. One or more blocks described herein may be performed by one or more elements of wireless device 22 such as by one or more of processing circuitry 84 (including the RS determination unit 34), processor 86, radio interface 82 and/or communication interface 60. Wireless device 22 is configured to determine that a maximum permissible emission event has occurred for a current spatial domain transmission filter of the WD 22 (Block S142). The process also includes selecting at least one candidate downlink reference signal (Block S144). The process further includes reporting the selected candidate downlink reference signal to the network node 16 (Block S146).

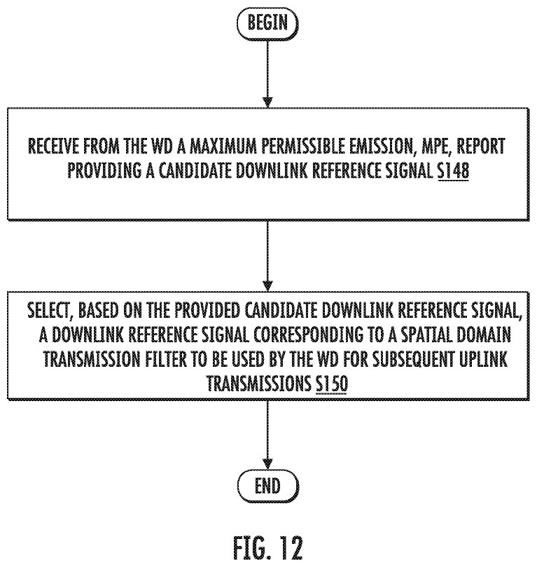

FIG. 12 is a flowchart of another example process in a network node 16 according to some embodiments of the present disclosure. One or more blocks described herein may be performed by one or more elements of network node 16 such as by one or more of processing circuitry 68 (including the WD configuration unit 32), processor 70, radio interface 62 and/or communication interface 60. Network node 16 is configured to receive from the WD 22 a maximum permissible emission, MPE, report providing a candidate downlink reference signal (Block S148). The process also includes selecting, based on the provided candidate downlink reference signal, a downlink reference signal corresponding to a spatial domain transmission filter to be used by the WD 22 for subsequent uplink transmissions(Block S150).

Having described the general process flow of arrangements of the disclosure and having provided examples of hardware and software arrangements for implementing the processes and functions of the disclosure, the sections below provide details and examples of arrangements for beam reporting at power limitation.

As mentioned, it has been specified that the WD 22 should be able to report to the network node 16, e.g., a gNB, that the WD 22 reduces its transmit power due to MPE. This is referred to herein as an MPE report. In one embodiment, the WD 22 provides the network node 16 with a candidate DL RS in the MPE report. The network node 16 may then signal to the WD 22 that the WD 22 is to use the UL beam corresponding to that DL RS for future UL transmissions. In one embodiment, the WD 22 continues to use that UL beam until the WD 22 is explicitly provided with a new spatial relation.

In some embodiments, the WD 22 also provides information about the quality of the candidate DL RS. One example of such quality information is the DL RSRP. In some embodiments, the WD 22 provides information about the difference in quality between an UL transmission using the current beam and a beam corresponding to the candidate DL RS, taking the reduction of transmit power for the current beam into account. Based on this information, the network node 16 may decide if it will continue to use the current beam, or to switch to the new candidate beam.

In some embodiments, the WD 22 includes information, which may be considered quality information, for N number of SSB beams (or other DL-RSs), their corresponding RSRP values (or another DL related performance metric) and their corresponding UL related performance metric (such as maximum available output power, power head room report value, or P-MPR value). In this way, the network node 16 may seek full information about how suitable different beam pair links will be for UL communication. To fully understand the usability of a certain beam pair link for UL communication it may be necessary for the network node 16 to have an understanding of both the path gain for a certain beam pair link and the available UL output power associated with that beam pair link. For example, if the system is interference limited in the uplink, then it is usually preferred to select a beam pair link with as high a path gain as possible in order to minimize the used UL output power and therefore minimize the generated inter-cell interference.

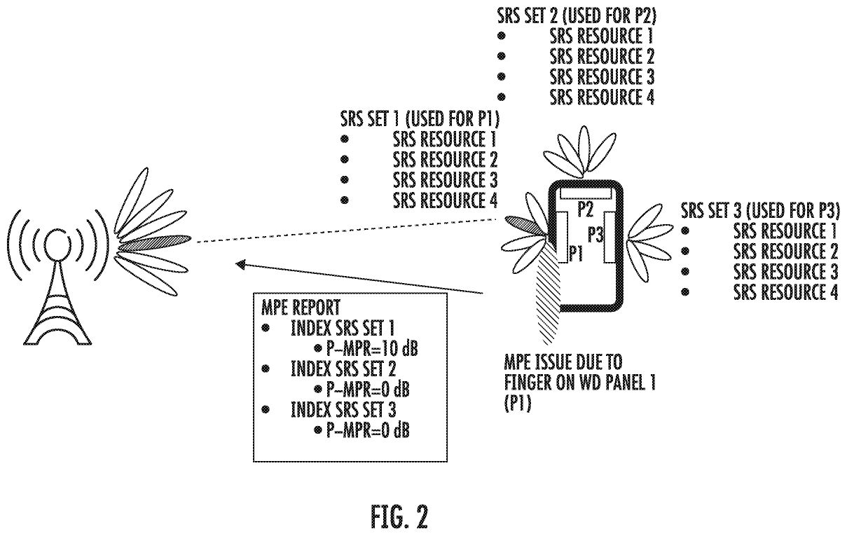

In some embodiments, when multiple values are reported, differential reporting is used. In some embodiments, SRS resources may be used as source reference signals in spatial relations. In some embodiments UL transmission configuration indicator (TCI) states might be specified instead of spatial relations in 3GPP Release 17. The WD 22 can signal one or multiple SRS resource(s) and/or SRS resource set(s) to indicate one or several new preferred WD panel(s). The network node 16 may then signal to the WD 22 that the WD 22 is to use an UL beam corresponding to one of the indicated SRS resource(s) and/or SRS resource set(s) for future UL transmissions. In some embodiments, the WD 22 signals an output power related metric (like maximum available output power, power head room report value, or P-MPR value) for each indicated SRS resource and/or SRS resource set in the MPE report. One example of this embodiment is illustrated in FIG. 2.

In the example of FIG. 2, the WD 22 is equipped with three panels, P1, P2 and P3, and are configured with one SRS resource set per WD panel. Assume that the WD 22 currently is configured with an SRS resource from SRS resource set 1 as the spatial relation for UL signals. Assume further that the WD panel associated with SRS resource set 1, P1, gets affected by MPE, which causes the WD 22 to trigger an MPE event and signal a MPE report to the network node 16. In this example, the MPE report may include indices to all three SRS resource sets and an associated P-MPR value for each corresponding WD panel. In this way, the network node 16 can determine an SRS resource from a suitable SRS resource set to be used as a spatial relation (or UL TCI state) for coming UL transmissions. Note that this example assumes that there is one common P-MPR value for all beams belonging to one WD panel, which is likely to be the case.

In some embodiments, the index of the SRS resource set is not needed. Instead, the SRS resource set indices are implicitly known by the network node 16 and WD 22, and the WD 22 only indicates a list of P-MPR (or similar UL related metric). For example, the first P-MPR values in that list can be associated with the SRS resource set with usage ‘beamManagement’ with lowest SRS resource set ID, and so on. Note that in this example, the WD 22 reports one P-MPR value for each SRS resource set to be useful.

In some embodiments, the MPE report contains one P-MPR or similar UL power indication for each SRS resource of an SRS resource set with usage ‘antennaSwitching’.

Some embodiments include a method in a WD 22, where the WD 22 has detected that it must reduce the transmit power for the current beam, includes reporting a candidate DL RS (or UL RS/UL RS set) that the WD 22 prefers to use for subsequent UL transmissions.

According to one aspect of the present disclosure, a method in a wireless device, WD 22 that is configured to communicate with a network node 16 is provided. The method includes determining that a maximum permissible emission event has occurred for a current spatial domain transmission filter of the WD 22, selecting at least one candidate downlink reference signal, and reporting the selected candidate downlink reference signal to the network node 16.

According to one or more embodiments of this aspect, the candidate downlink reference signal corresponds to a candidate spatial domain transmission filter of the WD 22. According to further embodiments the WD 22 may receive from the network node 16 an indication of a spatial domain transmission filter to be used by the WD 22 for uplink transmissions. According to one or more embodiments of this aspect, the reporting further includes reporting quality information of the candidate downlink reference signal to the network node 16. According to one or more embodiments of this aspect, the quality information includes a difference in quality between using the current spatial domain transmission filter and using a spatial domain transmission filter corresponding to the selected candidate downlink reference signal for an uplink, UL, transmission, taking a reduction of transmit power for the current spatial domain transmission filter into account.

According to one or more embodiments of this aspect, the candidate downlink reference signal is a synchronization signal block, SSB, signal or a channel state information reference signal, CSI-RS. According to one or more embodiments of this aspect, the candidate downlink reference signal includes a plurality of candidate downlink reference signals where the reporting includes reporting quality information of a first candidate downlink reference signal of the plurality of candidate downlink reference signals and reporting a difference between the quality information of the first candidate downlink reference signal and corresponding quality information of at least one of the remaining candidate downlink reference signals of the plurality of candidate downlink reference signals. According to one or more embodiments of this aspect, the reporting further includes reporting a power management maximum power reduction, P-MPR, value for a spatial domain transmission filter corresponding to the selected candidate downlink reference signal.

According to another aspect of the present disclosure, a wireless device, WD 22, configured to communicate with a network node 16 is provided. The WD 22 includes processing circuitry 84 configured to: determine that a maximum permissible emission event has occurred for a current spatial domain transmission filter of the WD 22, and select at least one candidate downlink reference signal. The WD 22 includes a radio interface 82 in communication with the processing circuitry and configured to: report the selected candidate downlink reference signal to the network node 16.

According to one or more embodiments of this aspect, the candidate downlink reference signal corresponds to a candidate spatial domain transmission filter of the WD 22. According to one or more embodiments of this aspect, the radio interface 82 is further configured to receive from the network node 16 an indication of a spatial domain transmission filter to be used by the WD 22 for uplink transmissions. According to one or more embodiments of this aspect, the radio interface 82 being configured to report further comprises the radio interface 82 being configured to report quality information of the candidate downlink reference signal to the network node 16.

According to one or more embodiments of this aspect, the quality information includes a difference in quality between using the current spatial domain transmission filter and using a spatial domain transmission filter corresponding to the selected candidate downlink reference signal for an uplink, UL, transmission, taking a reduction of transmit power for the current spatial domain transmission filter into account. According to one or more embodiments of this aspect, the candidate downlink reference signal is a synchronization signal block, SSB, signal or a channel state information reference signal, CSI-RS. According to one or more embodiments of this aspect, the candidate downlink reference signal comprises a plurality of candidate downlink reference signals where the reporting includes reporting quality information of a first candidate downlink reference signal of the plurality of candidate downlink reference signals and reporting a difference between the quality information of the first candidate downlink reference signal and corresponding quality information of at least one of the remaining candidate downlink reference signals of the plurality of candidate downlink reference signals. According to one or more embodiments of this aspect, the radio interface 83 being configured to report further comprises the radio interface 83 being configured to report a power management maximum power reduction, P-MPR, value for a spatial domain transmission filter corresponding to the selected candidate downlink reference signal.

According to another aspect of the disclosure, a method in a network node 16 that is configured to communicate with a wireless device, WD 22 is provided. The method includes receiving from the WD 22 a maximum permissible emission, MPE, report providing a candidate downlink reference signal, and selecting, based on the provided candidate downlink reference signal, a downlink reference signal corresponding to a spatial domain transmission filter to be used by the WD 22 for subsequent uplink transmissions.

According to one or more embodiments of this aspect, the method further includes transmitting to the WD 22 an indication of the spatial domain transmission filter to be used by the WD 22 for uplink transmissions. According to one or more embodiments of this aspect, the receiving further comprises receiving quality information of the candidate downlink reference signal from the WD 22. The quality information of the candidate downlink reference signal may be provided by the WD 22 in the MPE report.

According to one or more embodiments of this aspect, the selected downlink reference signal is one of a current downlink reference signal corresponding to a current spatial domain transmission filter used by the WD 22 for uplink transmissions and the provided candidate downlink reference signal corresponding to a candidate spatial domain transmission filter of the WD 22 for subsequent uplink transmissions. According to one or more embodiments of this aspect, selecting the downlink reference signal corresponding to the spatial domain transmission filter to be used by the WD 22 for subsequent uplink transmissions includes selecting an uplink-downlink beam pair that provides a highest path gain between the network node 16 and the WD 22.

According to another aspect of the disclosure, a network node 16 configured to communicate with a wireless device, WD 22 is provided. The network node 16 includes a radio interface 62 configured to receive from the WD 22 a maximum permissible emission, MPE, report providing a candidate downlink reference signal. The network node 16 includes processing circuitry in communication with the radio interface and configured to select, based on the provided candidate downlink reference signal, a downlink reference signal corresponding to a spatial domain transmission filter to be used by the WD 22 for subsequent uplink transmissions.

According to one or more embodiments of this aspect, the radio interface 62 is configured to transmit to the WD 22 an indication of the spatial domain transmission filter to be used by the WD 22 for uplink transmissions. According to one or more embodiments of this aspect, the radio interface 62 being configured to receive further includes the radio interface 62 being configured to receive quality information of the candidate downlink reference signal from the WD 22.

According to one or more embodiments of this aspect, the selected downlink reference signal is one of a current downlink reference signal corresponding to a current spatial domain transmission filter used by the WD 22 for uplink transmissions and the provided candidate downlink reference signal corresponding to a candidate spatial domain transmission filter of the WD 22 for subsequent uplink transmissions. According to one or more embodiments of this aspect, selecting the downlink reference signal corresponding to the spatial domain transmission filter to be used by the WD 22 for subsequent uplink transmissions includes selecting an uplink-downlink beam pair that provides a highest path gain between the network node 16 and the WD 22.

It is noted that the candidate spatial domain transmission filter may be different from the current spatial domain transmission filter. The candidate spatial domain transmission filter and the current spatial domain transmission filter may in some embodiments comprise a candidate uplink transmission beam and a current uplink transmission beam, respectively. Alternatively or additionally, the candidate spatial domain transmission filter and the current spatial domain transmission filter may in some examples comprise a candidate antenna panel and a current antenna panel respectively. In some embodiments, the indication of the spatial transmission filter may be an indication of the downlink reference signal corresponding to the spatial domain transmission filter to be used by the WD 22 for subsequent uplink transmissions. In some embodiments, the spatial domain transmission filter indicated by the network node 16 may be a current spatial domain transmission filter, a candidate spatial domain transmission filter selected/preferred by the WD (22) or another spatial domain transmission filter selected by the network node (16).

It is further noted that the reporting by the WD 22 to the network node 16 may comprise sending a MPE report. The candidate downlink reference signal selected by the WD 22 may be provided in the MPE report. The MPE report may be (or comprise) a P-MPR report. The P-MPR report may be a Power Headroom Report (PHR) that includes a P-MPR value.

According to one aspect, a network node 16 is configured to communicate with a wireless device (WD). The network node 16 includes a radio interface 62 and/or comprising processing circuitry 68 configured to receive from the WD 22 a candidate downlink reference signal (RS), and configure the WD 22 to use the candidate downlink RS for future uplink transmission.

According to this aspect, in some embodiments, the downlink reference signal is a sounding reference signal (SRS). In some embodiments, the network node 16, radio interface 62 and/or processing circuitry 68 is further configured to configure the WD 22 to use an uplink beam corresponding to the SRS. In some embodiments, the network node 16, radio interface 62 and/or processing circuitry 68 is configured to decide whether to use a current beam or to switch to different beam.

According to another aspect, a method implemented in a network node 16 includes receiving from the WD 22 a candidate downlink reference signal (RS), and configuring the WD 22 to use the candidate downlink RS for future uplink transmission.

According to this aspect, in some embodiments, the downlink reference signal is a sounding reference signal (SRS). In some embodiments, the network node 16, radio interface and/or processing circuitry is further configured to configure the WD 22 to use an uplink beam corresponding to the SRS. In some embodiments, the method includes deciding whether to use a current beam or to switch to different beam.

According to yet another aspect, a WD 22 is configured to communicate with a network node 16. The WD 22 includes a radio interface 82 and/or processing circuitry 84 configured to transmit to the network node 16 a candidate downlink reference signal (RS), and receive from the network node 16 an instruction to use an uplink beam corresponding to the candidate RS in future uplink transmissions.

According to this aspect, in some embodiments, the WD 22, radio interface 82 and/or processing circuitry 84 is configured to transmit to the network node 16, quality information about the candidate downlink RS. In some embodiments, the WD 22, radio interface 82 and/or processing circuitry 84 is configured to transmit to the network node 16, a difference in quality between an uplink transmission using a current beam and a beam corresponding to the candidate downlink RS. In some embodiments, the WD 22, processing circuitry 84 and/or radio interface 82 are further configured to transmit to the network node 16, information for N number of synchronization signal block beams, the information including reference signal received power (RSRP) values. In some embodiments, the WD 22, processing circuitry 84 and/or radio interface 82 are further configured to transmit to the network node 16, multiple sounding reference signals (SRS) to indicate at least one preferred panel. In some embodiments, the WD 22, processing circuitry 84 and/or radio interface 82 are further configured to transmit to the network node 16, a power metric for each SRS. In some embodiments, the WD 22, processing circuitry 84 and/or radio interface 82 are further configured to transmit to the network node 16, at least one power management maximum power reduction value.

According to another aspect, a method implemented in a wireless device (WD) includes transmitting to the network node 16 a candidate downlink reference signal (RS), and receiving from the network node 16 an instruction to use an uplink beam corresponding to the candidate RS in future uplink transmissions.

According to this aspect, in some embodiments the method includes transmitting to the network node 16, quality information about the candidate downlink RS. In some embodiments, the method includes transmitting to the network node 16, a difference in quality between an uplink transmission using a current beam and a beam corresponding to the candidate downlink RS. In some embodiments, the method includes transmitting to the network node 16, information for N number of synchronization signal block beams, the information including reference signal received power (RSRP) values. In some embodiments, the method further includes transmitting to the network node 16, multiple sounding reference signals (SRS) to indicate at least one preferred panel. In some embodiments, the method further includes transmitting to the network node 16, a power metric for each SRS. In some embodiments, the method further includes transmitting to the network node 16, at least one power management maximum power reduction value. Some examples may include one or more of the following.

Embodiment A1. A network node 16 configured to communicate with a wireless device 22 (WD 22), the network node 16 configured to, and/or comprising a radio interface 62 and/or comprising processing circuitry 68 configured to:
receive from the WD 22 a candidate downlink reference signal (RS); and
configure the WD 22 to use the candidate downlink RS for future uplink transmission.

Example A2. The network node 16 of Example A1, wherein the downlink reference signal is a sounding reference signal (SRS).

Example A3. The network node 16 of Example A2, wherein the network node 16, radio interface 62 and/or processing circuitry 68 is further configured to configure the WD 22 to use an uplink beam corresponding to the SRS.

Example A4. The network node 16 of any of Examples A1-A3, wherein the network node 16, radio interface 62 and/or processing circuitry 68 is configured to decide whether to use a current beam or to switch to different beam.

Example B1. A method implemented in a network node 16, the method comprising:
receiving from the WD 22 a candidate downlink reference signal (RS); and
configuring the WD 22 to use the candidate downlink RS for future uplink transmission.

Example B2. The method of Example B1, wherein the downlink reference signal is a sounding reference signal (SRS).

Example B3. The method of Example B2, wherein the network node 16, radio interface 62 and/or processing circuitry 68 is further configured to configure the WD 22 to use an uplink beam corresponding to the SRS.

Example B4. The method of any of Examples B1-B3, further comprising deciding whether to use a current beam or to switch to different beam.

Example C1. A wireless device 22 (WD 22) configured to communicate with a network node 16, the WD 22 configured to, and/or comprising a radio interface 62 and/or processing circuitry 68 configured to:
transmit to the network node 16 a candidate downlink reference signal (RS); and
receive from the network node 16 an instruction to use an uplink beam corresponding to the candidate RS in future uplink transmissions.

Example C2. The WD 22 of Example C1, wherein the WD 22, radio interface 62 and/or processing circuitry 68 is configured to transmit to the network node 16, quality information about the candidate downlink RS.

Example C3. The WD 22 of Example C1, wherein the WD 22, radio interface 62 and/or processing circuitry 68 is configured to transit to the network node 16, a difference in quality between an uplink transmission using a current beam and a beam corresponding to the candidate downlink RS.

Example C4. The WD 22 of any of Examples C1-C3, wherein the WD 22, processing circuitry 84 and/or radio interface 82 are further configured to transmit to the network node 16, information for N number of synchronization signal block beams, the information including reference signal received power (RSRP) values.

Example C5. The WD 22 of any of Examples C1-C4, wherein the WD 22, processing circuitry 84 and/or radio interface 82 are further configured to transmit to the network node 16, multiple sounding reference signals (SRS) to indicate at least one preferred panel.

Example C6. The WD 22 of Example C5, wherein the WD 22, processing circuitry 84 and/or radio interface 82 are further configured to transmit to the network node 16, a power metric for each SRS.

Example C7. The WD 22 of any of Examples C1-C6, wherein the WD 22, processing circuitry 84 and/or radio interface 82 are further configured to transmit to the network node 16, at least one power management maximum power reduction value.

Example D1. A method implemented in a wireless device 22 (WD 22), the method comprising:
transmitting to the network node 16 a candidate downlink reference signal (RS); and
receiving from the network node 16 an instruction to use an uplink beam corresponding to the candidate RS in future uplink transmissions.

Example D2. The method of Example D1, further comprising transmitting to the network node 16, quality information about the candidate downlink RS.

Example D3. The method of Example D1, further comprising transmitting to the network node 16, a difference in quality between an uplink transmission using a current beam and a beam corresponding to the candidate downlink RS.

Example D4. The method of any of Examples D1-D3, further comprising transmitting to the network node 16, information for N number of synchronization signal block beams, the information including reference signal received power (RSRP) values.

Example D5. The method of any of Examples D1-D4, further comprising transmitting to the network node 16, multiple sounding reference signals (SRS) to indicate at least one preferred panel.

Example D6. The method of Example D5, further comprising transmitting to the network node 16, a power metric for each SRS.

Example D7. The method of any of Examples D1-D6, further comprising transmitting to the network node, at least one power management maximum power reduction value.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a wireless device, WD, configured to communicate with a network node, the method comprising:
determining that a maximum permissible emission event has occurred for a current spatial domain transmission filter of the WD;
selecting at least one candidate downlink reference signal; and
reporting the selected candidate downlink reference signal to the network node.

2. The method of claim 1, wherein the candidate downlink reference signal corresponds to a candidate spatial domain transmission filter of the WD.

3. The method of claim 1, further comprising receiving from the network node an indication of a spatial domain transmission filter to be used by the WD for uplink transmissions.

4. The method of claim 1, wherein the reporting further comprises reporting quality information of the candidate downlink reference signal to the network node.

5. The method of claim 4, wherein the quality information includes a difference in quality between using the current spatial domain transmission filter and using a spatial domain transmission filter corresponding to the selected candidate downlink reference signal for an uplink, UL, transmission, taking a reduction of transmit power for the current spatial domain transmission filter into account.

6. The method of claim 1, wherein the candidate downlink reference signal is a synchronization signal block, SSB, signal or a channel state information reference signal, CSI-RS.

7. The method of claim 1, wherein the candidate downlink reference signal comprises a plurality of candidate downlink reference signals and wherein the reporting includes reporting quality information of a first candidate downlink reference signal of the plurality of candidate downlink reference signals and reporting a difference between the quality information of the first candidate downlink reference signal and corresponding quality information of at least one of the remaining candidate downlink reference signals of the plurality of candidate downlink reference signals.

8. The method of claim 1, wherein the reporting further comprises reporting a power management maximum power reduction, P-MPR, value for a spatial domain transmission filter corresponding to the selected candidate downlink reference signal.

9. A wireless device, WD, configured to communicate with a network node, the WD comprising:
processing circuitry configured to:
determine that a maximum permissible emission event has occurred for a current spatial domain transmission filter of the WD;
select at least one candidate downlink reference signal; and
a radio interface in communication with the processing circuitry and configured to:
report the selected candidate downlink reference signal to the network node.

10. The WD of claim 9, wherein the candidate downlink reference signal corresponds to a candidate spatial domain transmission filter of the WD.

11. The WD of claim 9, wherein the radio interface is further configured to receive from the network node an indication of a spatial domain transmission filter to be used by the WD for uplink transmissions.

12. The WD of claim 9, wherein the radio interface being configured to report further comprises the radio interface being configured to report quality information of the candidate downlink reference signal to the network node.

13. The WD of claim 12, wherein the quality information includes a difference in quality between using the current spatial domain transmission filter and using a spatial domain transmission filter corresponding to the selected candidate downlink reference signal for an uplink, UL, transmission, taking a reduction of transmit power for the current spatial domain transmission filter into account.

14. The WD of claim 9, wherein the candidate downlink reference signal is a synchronization signal block, SSB, signal or a channel state information reference signal, CSI-RS.

15. The WD of claim 9, wherein the candidate downlink reference signal comprises a plurality of candidate downlink reference signals and wherein the reporting includes reporting quality information of a first candidate downlink reference signal of the plurality of candidate downlink reference signals and reporting a difference between the quality information of the first candidate downlink reference signal and corresponding quality information of at least one of the remaining candidate downlink reference signals of the plurality of candidate downlink reference signals.

16. The WD of claim 9, wherein the radio interface being configured to report further comprises the radio interface being configured to report a power management maximum power reduction, P-MPR, value for a spatial domain transmission filter corresponding to the selected candidate downlink reference signal.

17. A method in a network node configured to communicate with a wireless device, WD, the method comprising:
receiving from the WD a maximum permissible emission, MPE, report providing a candidate downlink reference signal;
selecting, based on the provided candidate downlink reference signal, a downlink reference signal corresponding to a spatial domain transmission filter to be used by the WD for subsequent uplink transmissions.

18. The method of claim 17, further comprising transmitting to the WD an indication of the spatial domain transmission filter to be used by the WD for uplink transmissions.

19. The method of claim 17, wherein the receiving further comprises receiving quality information of the candidate downlink reference signal from the WD.

20. The method of claim 17, wherein the selected downlink reference signal is one of a current downlink reference signal corresponding to a current spatial domain transmission filter used by the WD for uplink transmissions and the provided candidate downlink reference signal corresponding to a candidate spatial domain transmission filter of the WD for subsequent uplink transmissions.

21. The method of claim 17, wherein selecting the downlink reference signal corresponding to the spatial domain transmission filter to be used by the WD for subsequent uplink transmissions includes selecting an uplink-downlink beam pair that provides a highest path gain between the network node and the WD.

22. A network node configured to communicate with a wireless device, WD, the network node comprising:
a radio interface configured to:
receive from the WD a maximum permissible emission, MPE, report providing a candidate downlink reference signal; and
processing circuitry in communication with the radio interface and configured to select, based on the provided candidate downlink reference signal, a downlink reference signal corresponding to a spatial domain transmission filter to be used by the WD for subsequent uplink transmissions.

23. The network node of claim 22, further comprising the radio interface being configured to transmit to the WD an indication of the spatial domain transmission filter to be used by the WD for uplink transmissions.

24. The network node of claim 22, wherein the radio interface being configured to receive further comprises the radio interface being configured to receive quality information of the candidate downlink reference signal from the WD.

25. The network node of claim 22, wherein the selected downlink reference signal is one of a current downlink reference signal corresponding to a current spatial domain transmission filter used by the WD for uplink transmissions and the provided candidate downlink reference signal corresponding to a candidate spatial domain transmission filter of the WD for subsequent uplink transmissions.

26. The network node of claim 22, wherein selecting the downlink reference signal corresponding to the spatial domain transmission filter to be used by the WD for subsequent uplink transmissions includes selecting an uplink-downlink beam pair that provides a highest path gain between the network node and the WD.
